(19) United States
(12) Patent Application Publication
(10) Pub. No.: US 2024/0249194 A1
(43) Pub. Date: Jul. 25, 2024

(54) SYSTEMS AND METHODS FOR MEASURING AND AUDITING FAIRNESS

(71) Applicant: Ohio State Innovation Foundation, Columbus, OH (US)

(72) Inventors: Pranav Maneriker, Columbus, OH (US); Srinivasan Parthasarathy, Columbus, OH (US); Codi Burley, Columbus, OH (US)

(21) Appl. No.: 18/419,130

(22) Filed: Jan. 22, 2024

Related U.S. Application Data
(60) Provisional application No. 63/440,223, filed on Jan. 20, 2023.

(51) Int. Cl. G06N 20/00

(52) U.S. Cl. CPC G06N 20/00

(57) ABSTRACT

An example computer-implemented method for measuring fairness includes obtaining a deployed model and an audit dataset associated with the deployed model, where the audit dataset is configured to evaluate model fidelity against one or more fairness metrics; specifying a fairness criterion on a plurality of population groups, the fairness criterion including one or more fairness metrics; performing an evaluation of the deployed model with respect to the fairness criterion, where the evaluation of the fairness criterion includes analyzing the audit dataset using the deployed model to predict a respective outcome metric for each of the population groups; and generating a visual diagnostic diagram for facilitating an analysis of potential failures of the deployed model with respect to the specified fairness criterion.

### CROSS-REFERENCE TO RELATED APPLICATIONS

This application claims the benefit of U.S. provisional patent application No. 63/440,223, filed on Jan. 20, 2023, and titled “SYSTEMS AND METHODS FOR MEASURING AND AUDITING FAIRNESS,” the disclosure of which is expressly incorporated herein by reference in its entirety.

### BACKGROUND

Machine learning algorithms can be used to make predictions and identify patterns. Thus, machine learning algorithms have applicability in planning and public policy applications. Machine learning algorithms can be “black box” algorithms that are not easily observable. These algorithms therefore are not susceptible to conventional auditing techniques (e.g., reviewing the algorithm's source code).

Therefore, there is a need for improved systems and methods for auditing and measuring fairness, and systems and methods for evaluating the fairness of machine learning algorithms.

### SUMMARY

In some aspects, the techniques described herein relate to a computer implemented method for measuring fairness, the method including: obtaining a deployed model and an audit dataset associated with the deployed model, wherein the audit dataset is configured to evaluate model fidelity against one or more fairness metrics; specifying a fairness criterion on a plurality of population groups, the fairness criterion including one or more fairness metrics; performing an evaluation of the deployed model with respect to the fairness criterion, wherein the evaluation of the fairness criterion includes analyzing the audit dataset using the deployed model to predict a respective outcome metric for each of the population groups; and generating a visual diagnostic diagram for facilitating an analysis of potential failures of the deployed model with respect to the specified fairness criterion.

In some aspects, the techniques described herein relate to a computer implemented method, wherein obtaining the deployed model further includes receiving the deployed model from a machine learning system, the machine learning system including a decision-making function, wherein the decision-making function includes varying degrees of human intervention.

In some aspects, the techniques described herein relate to a computer implemented method, wherein the decision-making function is unknown.

In some aspects, the techniques described herein relate to a computer implemented method, wherein the decision-making function is arbitrary.

In some aspects, the techniques described herein relate to a computer implemented method, wherein performing the evaluation of the deployed model includes performing a sequence of estimates and generating a confidence set.

In some aspects, the techniques described herein relate to a computer implemented method, wherein the audit dataset includes data representing a relationship between an outcome metric and a population group.

In some aspects, the techniques described herein relate to a computer implemented method, wherein the outcome data includes data representing a relationship between an outcome metric and a plurality of population groups.

In some aspects, the techniques described herein relate to a computer implemented method, wherein the visual diagnostic diagram is a syntax tree.

In some aspects, the techniques described herein relate to a computer implemented method, wherein the syntax tree includes an interactive syntax tree.

In some aspects, the techniques described herein relate to a computer implemented method, wherein performing an evaluation of the deployed model includes evaluating the deployed model based on a grammar.

In some aspects, the techniques described herein relate to a computer implemented method, further including evaluating the deployed model based on a user input and outputting a revised output value.

In some aspects, the techniques described herein relate to a computer implemented method, wherein the fairness criterion is predefined or dynamically varied.

In some aspects, the techniques described herein relate to a computer implemented method, wherein the step of evaluating the deployed model is performed iteratively or continuously.

In some aspects, the techniques described herein relate to a computer implemented method, wherein the step of evaluating the deployed model is performed without assumptions about the deployed model.

In some aspects, the techniques described herein relate to a system including: a display; a computing device operably coupled to the display, wherein the computing device includes at least one processor and memory, the memory having computer-executable instructions stored thereon that, when executed by the at least one processor, cause the at least one processor to: obtain a deployed model and an audit dataset associated with the deployed model, the dataset including evaluation data; specify a fairness criterion on a plurality of population groups, the fairness criterion including one or more fairness metrics; perform an evaluation of the deployed model with respect to the fairness criterion, wherein the evaluation of the fairness criterion includes analyzing the audit dataset using the deployed model to predict a respective outcome metric for each of the population groups; generate a visual diagnostic diagram for facilitating an analysis of potential failures of the deployed model with respect to the specified fairness criterion; and display, by the display, the visual diagnostic diagram.

In some aspects, the techniques described herein relate to a system, wherein the computing device is further configured to: receive a user input, evaluate the deployed model based on the user input, and output a revised output value by the display.

In some aspects, the techniques described herein relate to a system, wherein the computing device is configured to iteratively or continuously evaluate the deployed model.

In some aspects, the techniques described herein relate to a system, wherein the visual diagnostic diagram is a syntax tree.

In some aspects, the techniques described herein relate to a system, wherein the syntax tree includes an interactive syntax tree.

In some aspects, the techniques described herein relate to a system, wherein the computing device is further configured to obtain the deployed model from a machine learning system, the machine learning system including a decision-making function wherein the decision-making function includes varying degrees of human intervention.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a method of measuring or auditing fairness of a deployed machine learning model, according to implementations of the present disclosure.

FIG. 2 illustrates an example algorithm for auditing fairness, according to implementations of the present disclosure.

FIG. 3 illustrates a visual diagnostic diagram, according to implementations of the present disclosure.

FIG. 4 illustrates a system for auditing or measuring the fairness of a deployed machine learning model, according to implementations of the present disclosure.

FIG. 5 is an example computing device.

FIG. 6 illustrates failure probability δ of a Bernoulli r.v. vs concentrated around mean & for different n.

FIG. 7 illustrates an example implementation of the present disclosure finding a solution for a theoretical scenario δ1+δ2≤Δ under constraint ε1+ε2≤εT.

FIG. 8 illustrates an example grammar for a specification, where [symbol] E [symbol] refers to expressions of r.vs and [symbol] comp-op [symbol] =comparison operator ∈ {>, <, =, ≠}.

FIG. 9 illustrates a table of symbols used in an example implementation of the present disclosure.

FIG. 10 illustrates bounds for first half of a gender-fairness specification generated by example implementations of the present disclosure.

FIG. 11A illustrates group fairness study conducted using a demographic dataset, according to an example implementation of the present disclosure.

FIG. 11B illustrates a group fairness study conducted using a gender dataset, according to an example implementation of the present disclosure.

FIG. 12A illustrates a false positive rate bias specification, according to a study performed of an example implementation of the present disclosure.

FIG. 12B illustrates an analysis using false discovery rate, according to a study performed of an example implementation of the present disclosure.

FIG. 13 illustrates inference rules used in example implementations of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for reconstructing certain types of images, it will become evident to those skilled in the art that the implementations are not limited thereto, but are applicable for reconstructing any type of image.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

Described herein are systems and related methods for auditing and measuring fairness of machine learning models. As described in the Example, the systems and methods can include systems and methods for determining the fairness of machine learning models and visualizing the fairness of machine learning models.

Machine learning algorithms can be “black box” algorithms that are not easily observable. For example, machine learning algorithms can be trained using techniques that result in models that produce outputs without showing the user the way the outputs are created, or what specific inputs correlate to a given output. This can prevent biases in machine learning models from being detected when looking at any specific decision or output of the machine learning model. Additionally, real world scenarios are statistically challenging to test the fairness of during the use of a deployed machine learning model. Finally, visualizing measures of machine learning model fairness and visualizing whether a given model is fair based on certain tests are also challenging. Implementations of the present disclosure can overcome these challenges in measuring and visualizing the fairness of machine learning models. As described herein, example implementations of the present disclosure include systems and computer implemented methods that measure and/or visualize the fairness of deployed machine learning models, which can allow users to determine whether the deployed machine learning models are unfair and thus allow for models to be corrected to prevent unfairness.

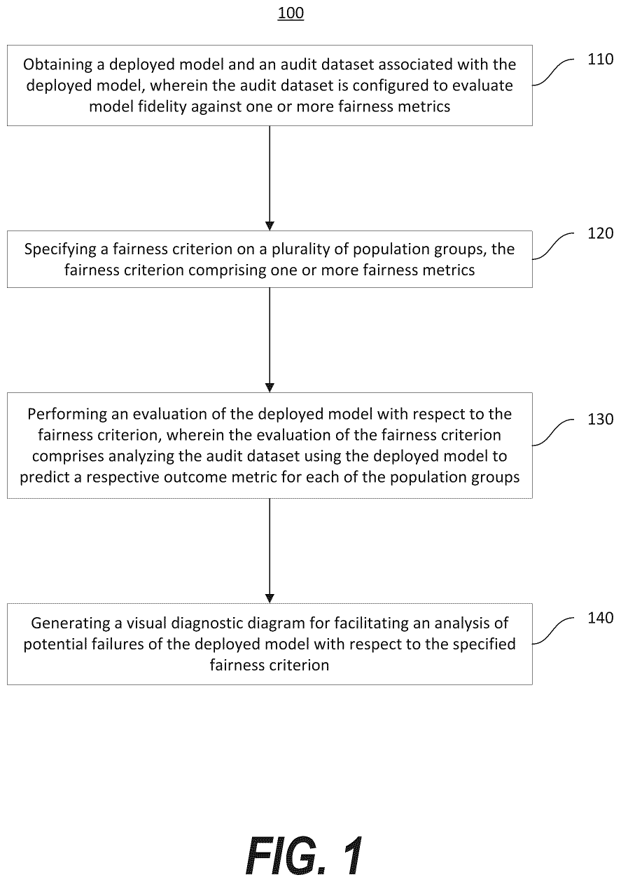

With reference to FIG. 1, a computer implemented method 100 for measuring fairness is shown. At step 110, the computer implemented method 100 can obtain a deployed model including a dataset associated with the deployed model. In some implementations, the dataset associated with the deployed model is an audit dataset. As used herein, the “audit dataset” is a dataset that can be used to audit the performance of a machine learning model. The audit dataset can optionally be a batch of data that includes less data than a full evaluation dataset. The audit dataset can be used in the method 100 to evaluate model fidelity against one or more fairness metrics.

As used herein, in some implementations, obtaining the deployed machine learning model means receiving the deployed machine learning model (e.g., receiving a file, computer program, etc.). In other implementations, obtaining the deployed machine learning model means accessing the deployed machine learning model, which executes on a remote system. Optionally, the dataset includes training data and/or evaluation (or test) data. Optionally, the deployed model can be received from a machine learning system. As a non-limiting example, the deployed model is a data structure (e.g., file, computer program, etc.) that represents a relationship between an outcome metric and a population group, and/or a data structure (e.g., file, computer program, etc.) that represents a relationship between an outcome metric and a plurality of population groups. For example, if the deployed machine learning model is an artificial neural network, the data structure defines, among other characteristics, the model's architecture (e.g., nodes, layers, etc.), node weights, biases, etc. Examples of data structures representing outcome metrics and population groups, as well as relationships between outcome metrics and data groups, are further described in the examples described herein.

Alternatively or additionally, the machine learning system can include a decision-making function. The present disclosure contemplates that machine learning systems using any decision-making function can be evaluated by the present disclosure. For example, in some implementations, the decision-making function is unknown. Alternatively or additionally, the decision-making function can be arbitrary.

At step 120, the computer implemented method 100 can include specifying a fairness criterion on one or more of population groups present within the dataset. Optionally, the fairness criterion can include one or more fairness metrics. Example fairness metrics are described in the study of example implementations of the present disclosure described herein.

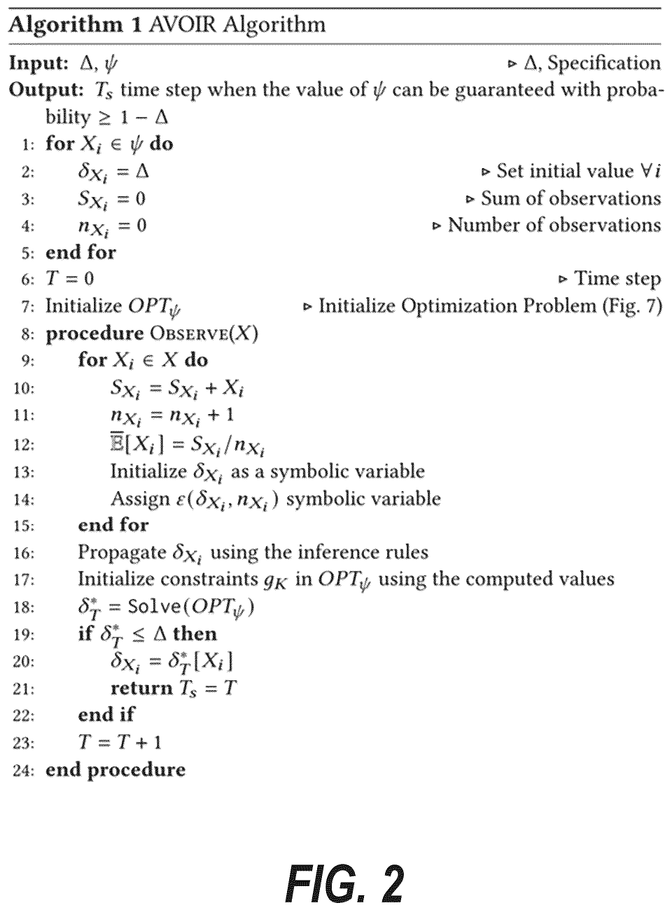

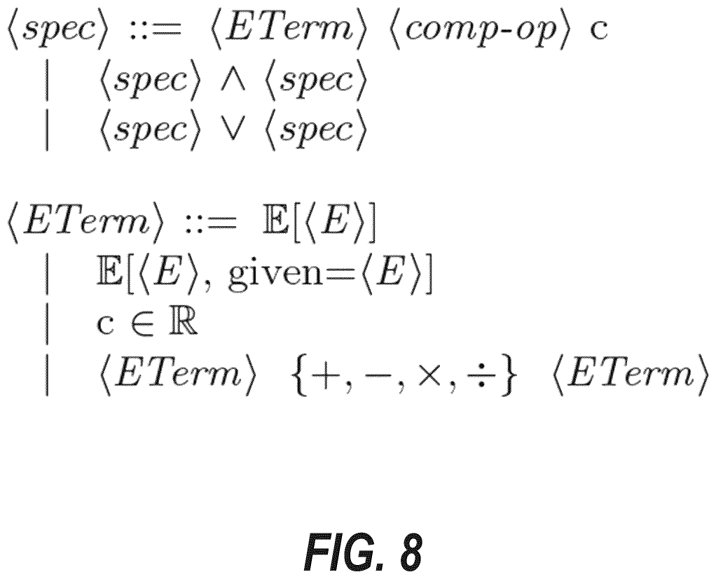

At step 130, the computer implemented method 100 can include performing an evaluation of the deployed model with respect to the fairness criterion. The evaluation of the fairness criterion can include analyzing the deployed model to predict a respective outcome metric for each of the population groups present within the dataset. An example algorithm that can be used to evaluate the deployed model with respect to a fairness criterion is illustrated in FIG. 2. Optionally, step 130 can further include evaluating the deployed model based on a grammar. Additional description of grammar and an example grammar are described in the example herein, for example with respect to FIG. 8.

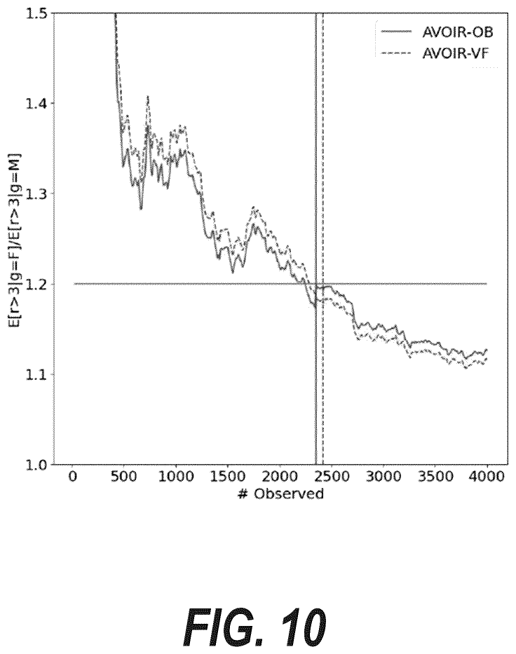

Optionally, step 130 can include evaluating the deployed model based on a user input and outputting a revised output value based on the user input. It should be understood that the steps of evaluating the deployed model and receiving user input can be performed any number of times. Alternatively or additionally, step 130 can be performed iteratively or continuously, for example in response to new or additional data being received. As another example, step 130 can further include performing a sequence of estimates and generating a confidence set. Additional details of the sequentially or iteratively performing step 130 are described in the example herein, for example with respect to FIG. 10.

In some implementations, the step 130 can be performed without assumptions about the deployed model.

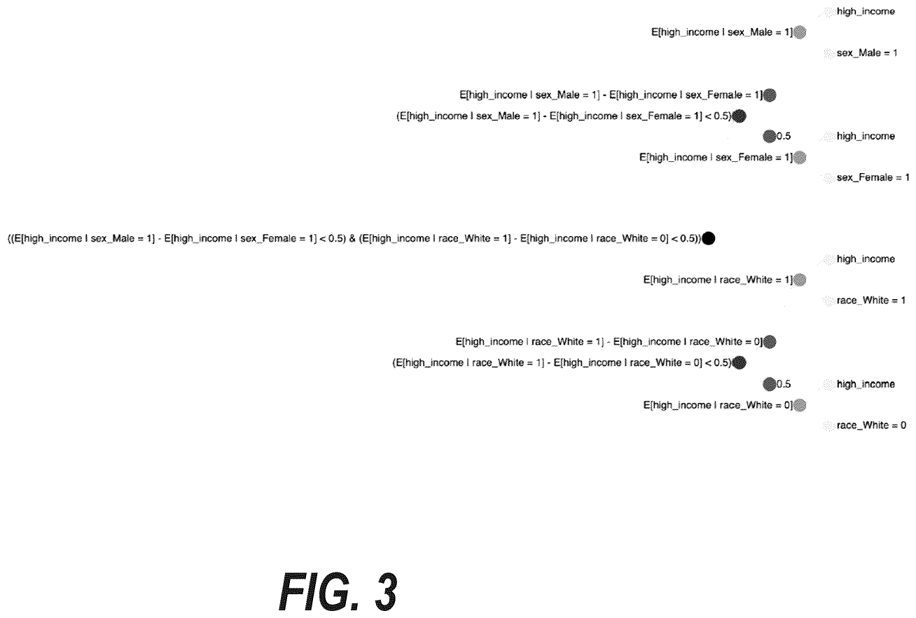

At step 140, the method can include generating a visual diagnostic diagram for facilitating the analysis of potential failures of the deployed model with respect to the specified fairness criterion. It should be understood that the fairness criterion can be predefined or dynamically varied in various implementations of the present disclosure. An example visualization of that can be generated at step 140 is shown in FIG. 3. Optionally, the visualization is interactive. A non-limiting example of an interactive visualization is an interactive syntax tree.

In some implementations, the visual diagnostic diagram can be a visual representation of a syntax tree. The syntax tree can represent the specification (e.g., the specification of a fairness criterion).

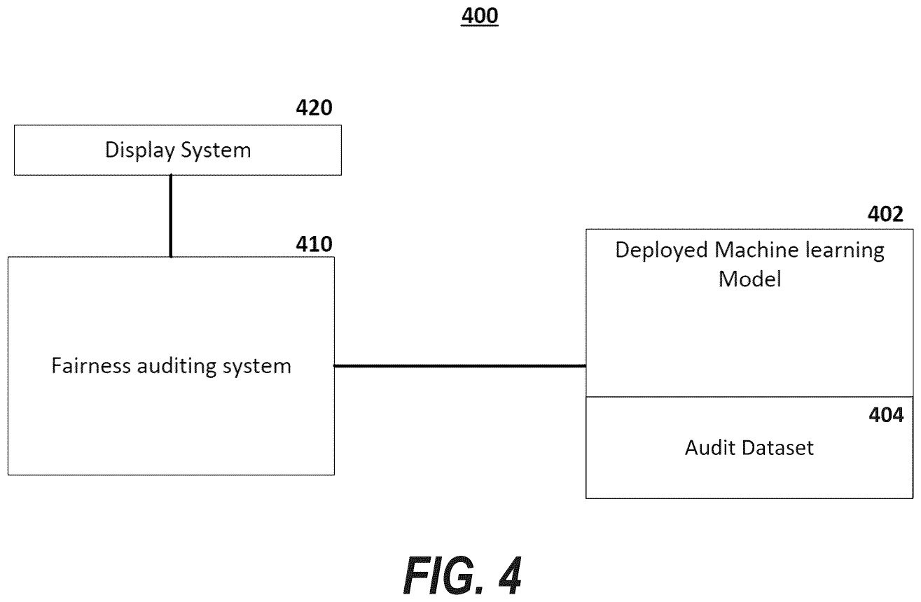

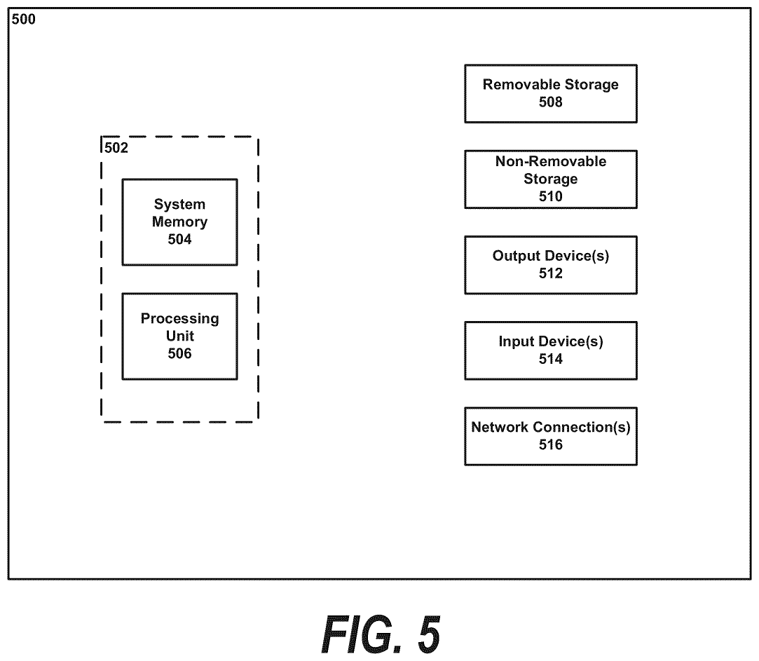

FIG. 4 illustrates an example system 400 for auditing the fairness of a deployed machine learning model 402. It should be understood that the deployed machine learning model 402 can be trained and executed (i.e. operated in inference mode) by a computing device such as the computing device 500 shown in FIG. 5. As used herein, the term “deployed machine learning model” and “deployed model” are interchangeable and can refer to any machine learning model that is has been trained to perform a task. For example, the deployed machine learning model can be a trained machine learning model. In other words, the deployed machine learning model is trained with training data, and/or evaluation data prior to its deployment.

Still with reference to FIG. 4, the system 400 can include a fairness auditing system 410. It should be understood that the fairness auditing system 410 can be implemented by a computing device such as the computing device 500 shown in FIG. 5. The fairness auditing system 410 can be operably connected to the deployed machine learning model such that the fairness auditing system 410 can obtain the deployed machine learning model 402. For example, in some implementations, the fairness auditing system 410 can receive the deployed machine learning model 402 (e.g., receive the file, computer program, etc.). In other implementations, the fairness auditing system 410 can access the deployed machine learning model 402, which executes on a remote system. Additionally, the fairness auditing system 410 can receive data used to train the deployed machine learning model 402. For example, the fairness auditing system 410 can receive the training data and/or evaluation data. The fairness auditing system 410 can also receive any outputs from the deployed machine learning model 402. In some implementations of the present disclosure, the fairness auditing system 410 receives an audit dataset 404, as described with reference to the method 100 shown in FIG. 1. In some implementations of the present disclosure, the audit dataset 404 can be a subset of the evaluation data.

The fairness auditing system 410 can be configured to perform any of the methods described herein. For example, the fairness auditing system 410 can be configured to perform the method 100 described with reference to FIG. 1.

Optionally, the fairness auditing system 410 can include a display module 420 configured to output a visual diagnostic diagram, as described with reference to FIGS. 1 and 3.

It should be appreciated that the logical operations described herein with respect to the various figures may be implemented (1) as a sequence of computer-implemented acts or program modules (i.e., software) running on a computing device (e.g., the computing device described in FIG. 5), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special-purpose digital logic, and any combination thereof. It should also be appreciated that more or fewer operations may be performed than shown in the figures and described herein. These operations may also be performed in a different order than those described herein.

Referring to FIG. 5, an example computing device 500 upon which the methods described herein may be implemented is illustrated. It should be understood that the example computing device 500 is only one example of a suitable computing environment upon which the methods described herein may be implemented. Optionally, the computing device 500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 500 typically includes at least one processing unit 506 and system memory 504. Depending on the exact configuration and type of computing device, system memory 504 may be volatile (such as random access memory (RAM)), non-volatile (such as read-only memory (ROM), flash memory, etc.), or some combination of the two. This most basic configuration is illustrated in FIG. 4 by dashed line 502. The processing unit 506 may be a standard programmable processor that performs arithmetic and logic operations necessary for operation of the computing device 500. The computing device 500 may also include a bus or other communication mechanism for communicating information among various components of the computing device 500.

Computing device 500 may have additional features/functionality. For example, computing device 500 may include additional storage such as removable storage 508 and non-removable storage 510 including, but not limited to, magnetic or optical disks or tapes. Computing device 500 may also contain network connection(s) 516 that allow the device to communicate with other devices. Computing device 500 may also have input device(s) 514 such as a keyboard, mouse, touch screen, etc. Output device(s) 512 such as a display, speakers, printer, etc. may also be included. The additional devices may be connected to the bus in order to facilitate communication of data among the components of the computing device 500. All these devices are well-known in the art and need not be discussed at length here.

The processing unit 506 may be configured to execute program code encoded in tangible, computer-readable media. Tangible, computer-readable media refers to any media that is capable of providing data that causes the computing device 500 (i.e., a machine) to operate in a particular fashion. Various computer-readable media may be utilized to provide instructions to the processing unit 506 for execution. Example tangible, computer-readable media may include, but is not limited to, volatile media, non-volatile media, removable media and non-removable media implemented in any method or technology for storage of information such as computer-readable instructions, data structures, program modules or other data. System memory 504, removable storage 508, and non-removable storage 510 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 506 may execute program code stored in the system memory 504. For example, the bus may carry data to the system memory 504, from which the processing unit 506 receives and executes instructions. The data received by the system memory 504 may optionally be stored on the removable storage 508 or the non-removable storage 510 before or after execution by the processing unit 506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

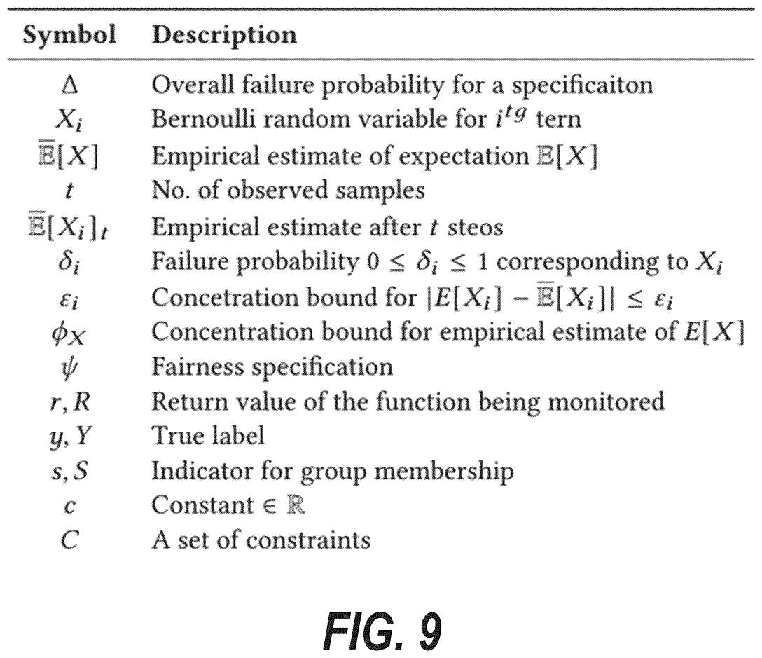

A sizable proportion of deployed machine learning models make their decisions in a black-box manner. Such decision-making procedures are susceptible to intrinsic biases, which can cause a need for accountability in deployed decision systems. An example implementation of the present disclosure was designed and studied. The example implementation of the present disclosure can audit the claimed mathematical guarantees of the fairness of such systems. The example implementation is referred to herein as “AVOIR,” and includes a system that reduces the number of observations required for the runtime monitoring of probabilistic assertions over fairness metrics specified on decision functions associated with black-box AI models. AVOIR provides an adaptive process that automates the inference of probabilistic guarantees associated with estimating a wide range of fairness metrics. In addition, AVOIR enables the exploration of fairness violations aligned with governance and regulatory requirements. The example includes case studies with fairness metrics on three different datasets and demonstrate how AVOIR can help detect and localize fairness violations and ameliorate the issues with faulty fairness metric design. FIG. 9 illustrates and describes the symbols used in the example.

Advanced analytics and artificial intelligence (AI), along with its many benefits, may pose significant threats to individuals and the broader society. Examples include invasion of privacy; manipulation of vulnerabilities; bias against protected classes; increased power imbalances; error; opacity and procedural unfairness; displacement of labor; pressure to conform, and intentional and harmful use as some of the key areas of concern. A core part of the solution to mitigate such risks is the need to make organizations accountable and ensure that the data they leverage and the models they build and use are both inclusive of marginalized groups and resilient against societal bias. Deployed AI and analytic systems are complex multistep processes that can incorporate several sources of risk at each step. At each of these stages, determining accountability in the decision-making of AI processes requires a determination of who is accountable, for what, to whom, and under what circumstances [10,34].

Implementations of the present disclosure include computer systems that audit fairness claims of mathematical guarantees associated with automated, black-box decision-making processes. Governments worldwide are wrestling with different implementations of auditing regulations and practices to increase the accountability of decision processes. Recent examples include the New York City auditing requirements for AI hiring tools [40], European data regulation (GDPR [36]), accountability bills [9, 35] and judicial reports [27]. These societal forces have led to the emergence of checklists [32, 37], metrics of fairness [41], and recently, algorithms and systems that observe the behavior of AI algorithms. [17]. The example implementation of AVOIR described herein can be configured to audit and/or verify fairness online. AVOIR includes distributional probabilistic fairness guarantees [2,4], and can generalize them to real-world data.

Fairness criteria quantify the relationship between the outcome metric across multiple subgroups or similar individuals in the population. Formal definitions of fairness focus on observational criteria, i.e., those that can be written down as a probability statement involving the joint distribution of the features, sensitive attributes, decision-making function, and actual outcome. Consider a decisionmaking function that claims to satisfy certain fairness guarantees. In this setup, auditing a claim about a fairness guarantee would involve quantifying the probability of claim violations. Given a particular failure probability Δ and a stream of data . . . , (Xₜ, Yₜ), . . . over time steps t at run time, a fairness claim ψ would be considered valid if Pr[∀t≥1, ψ]≥1−Δ. Assuming that the data is sampled from a fixed, possibly unknown distribution p_{data}, a common strategy to test the validity of a claim is to use hypothesis testing with a predetermined sample size m. However, it is impossible to know a priori whether m will be large enough to verify this hypothesis [44], and peeking at the data to determine the sample size would be considered ‘p-hacking.’ Collecting labeled data for fairness-related applications is expensive [26]; therefore, it is essential to ensure that a monitoring system used for auditing the fairness claim can adaptively and continuously update its estimates of the probability of validity. The example herein considers a claim as invalid if Pr[∀t≥1, ¬ψ]≥1−Δ, where ¬ denotes negation. Another desirable feature in the auditing system would be a finite-horizon stopping rule that should be able to decide the validity/invalidity of a claim, given sufficient data.

The example shows that the framework of confidence sequences/sets provides a mechanism for building confidence intervals for inference in sequential experiments with nonasymptotic (i.e., always valid for t≥1) intervals that approach zero width, ensuring that a stopping rule would have a finite termination. The example implementation can also localize and/or diagnose terms within a fairness metric that leads to the inference of a negated claim. For example, suppose r∈{0,1} denotes the return value of a binary decision function (say, job candidate selection), and s is an indicator denoting whether a candidate belongs to a minority population. The 80%-rule for disparate impact [14,15] is a fairness criterion which states that:

$$\frac{Pr [ r = 1 \vert s ]}{Pr [ r = 1 \vert ¬ s ]} \geq 0.8$$

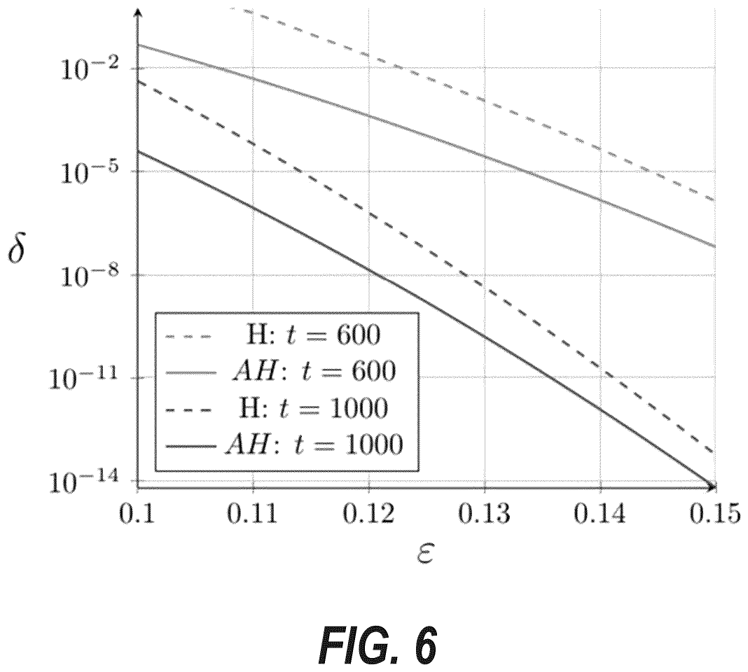

Assuming that a confidence sequence approach leads to the inference of a negated claim (invalid) for disparate impact, a diagnosis would determine whether the numerator or denominator in the criterion lead to the invalidity. AVOIR uses an inference framework that builds upon distributional guarantees for each term within the criterion, which can help with such a diagnosis. Further, overall uncertainty can be guaranteed across multiple groups by balancing it across subexpressions with differences in the number of observed samples. For example, consider Bernoulli r.vs ²X_{1,2} for which the example derives concentration guarantees Pr[ [symbol] [Xᵢ]− [symbol] [Xᵢ]|≥εᵢ]≤δᵢ after tᵢ observations. Here, [symbol] [X] refers to the population mean, [symbol] [X] refers to an empirical mean based on observations of X, and √, δ>0 are the concentration level and failure probability, respectively. From the Hoeffding inequality, δ=2e^{-2tε}^{²}. The example can claim tighter bounds for X₂ if t₂>t₁ as the failure probability δ is lower at the same concentration ε. That is, ε₁=ε₂, t₂>t₁⇒δ₁>δ₂. Varying ε across subexpressions to minimize the overall (union bounded) δ=δ₁+δ₂ allows an earlier stopping time for a valid/invalid claim, i.e., fewer iterations and fewer data samples. Adaptive versions of these inequalities also have similar patterns, as shown in FIG. 6, which illustrates failure probability of a Bernoulli r.v. vs concentrated around mean ε for different n. At the same concentration, lower failure probability for the majority class (greater n). (online) Hoeffding, Adaptive Hoeffding.

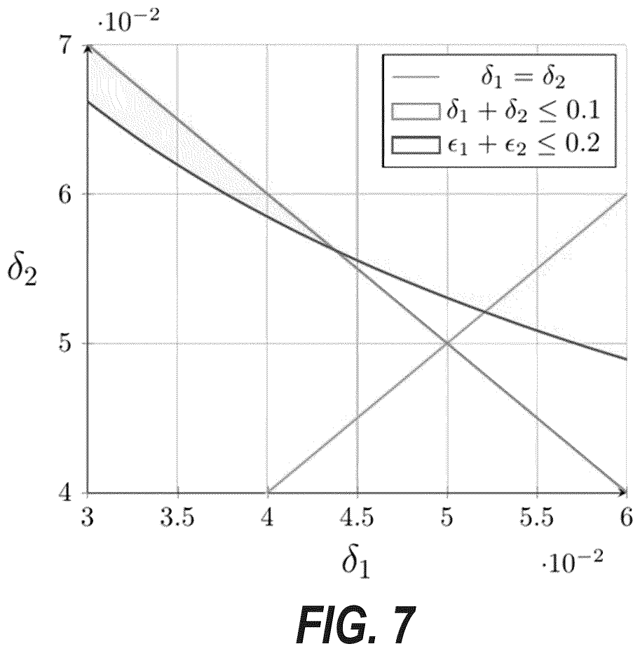

Consider R, a Bernoulli r.v corresponding to the output of a binary decision function, with s being an indicator of class membership. Let X=r∨s and Y=r∨¬s be r.vs corresponding to a favorable decision for the majority and minority classes, respectively. The example aims to estimate a criterion: ψ=E [X]−E[Y]<ε_{T} Previous work on inference from distributional guarantees [2,4] assumes equal failure probability across all groups, i.e., the assumption A_{δ}: =δ₁=δ₂ when the upper bound of the failure probability Δ=0.1 for the specified criterion. Consider a n_{X}, n_{Y} observations for X, Y such that [symbol] [X]=0.8, n_{X}=1550 and [symbol] [Y]=0.5, n_{Y}=310. FIG. 7 shows that in the example no solution is feasible for the optimization problem with A_{δ}. In FIG. 7, AVOIR finds a solution for a theoretical scenario with under constraint. No solution exists with additional constraint—common assumption in prior work. However, AVOIR can find a solution. For the optimal solution, δ₂≈2.3581, which aligns with our intuition about allocating higher failure probability to terms with the majority of observations. The optimization problem inferred by AVOIR:

$${min}_{{δ}_{X} , {δ}_{Y}} {δ}_{X} + {δ}_{y}$$

$$s . t .$$

$${ε}_{X} + {ε}_{Y} \leq \overline{𝔼} [ X ] - \overline{𝔼} [ Y ] - {ε}_{T}$$

The example shows that the example implementation includes advantages over FP [2] and VF [4].

(1) The example implementation of AVOIR in the framework of confidence sets [25] enables adaptive optimization of 8 across subexpressions of a specification. Note that FP only provides examples with equal splits while VF splits uncertainty equally across all elementary subexpressions.

(2) The confidence sets framework allows the example implementation to avoid assuming a known data distribution or fitting a density estimator over the population prior to fairness testing, which is required in VF.

(3) The example implementation augments the bound propagation rules to facilitate the online optimization process and allow propagation of constraints along with assertions at each iteration.

(4) The example implementation can include an inference engine that supports the automated inference of propagation rules for a wide range of metrics, with a finite stopping rule under mild conditions. The present example includes examples of inference over specifications involving multiple subexpressions, which are only possible by extending the implementations provided by previous work. The example implementation can optionally implement bound inference rules from VF (denoted AVOIR-VF) as a baseline.

(5) The example implementation can support diagnosis of fairness violations using bounds inferred for subexpressions. The example demonstrates the use of these cues to help drive the design of specifications described in the present example, which shows how a user may audit a fairness claim.

AVOIR can support implementing an extensive range of group fairness criteria, including demographic parity [6], equal opportunity [22], disparate mistreatment [46], and combinations of these criteria For instance the above 80%-rule is E[r|S==s]/E[r|S!=s]>0.8 in AVOIR's DSL³. Here, the term E[r|S==s]/E[r|S!=s] is a subexpression of the specification. The smallest units involving an expectation (e.g., E[r|S!=s]) are denoted as elementary subexpressions. The example described herein includes fairness criteria that can be expressed using Bernoulli r.v. as it allows the simplification of probabilities into expectation, as Pr[r=1]= [symbol] [r] (hereafter, used interchangably). The example algorithm described herein can use adaptive concentration sets [25,48] to build estimates for elementary subexpressions and then derive the estimates for expressions that combine them. A combination of multiple such elementary expressions is denoted as a compound expression. The example implementation can derive statistical guarantees about fairness criteria based on estimates from observed inputs and outputs. For example, let X be an observed Bernoulli r.v, then an assertion ϕ_{X}=( [symbol] [X],ε,δ) over X, corresponds to an estimate satisfying ϕ_{X}: =Pr[| [symbol] [X]− [symbol] [X]|≥ε]≤δ where [symbol] [X] denotes an empirical estimate of E [X]. The example implementation can use assertions ϕ_{X}, ϕ_{Y} to assert claims for expressions involving X, Y. For example, for the 80%-rule, assertions over [symbol] [X]/ [symbol] [Y]. A specification involves either a comparison of expressions with constants (e.g., [symbol] [X]/ [symbol] [Y]>0.8) or combinations of multiple such comparisons. Such a specification may be True (T) or False (F) with some probability. For a given specification ψ, the example denotes the claim that P[ψ=F]≥1−Δ as ψ: (F, Δ), where Δ denotes the failure probability of a guarantee. Given a stream of observations and outcomes from the decision functions, and a specified threshold probability Δ, the example implementation can continue to refine the estimate for a given specification until the threshold. Specifications involving variables that take more than two values can be implemented using transformations and boolean operators.

FIG. 8 illustrates grammar for specification where [symbol] E [symbol] refers to expressions of r.vs and [symbol] comp−op [symbol] =comparison operator ∈{>, <, =, ≠}.

The example described AVOIR's DSL used for specifying fairness metrics, shown in FIG. 8. The example implementation includes binary decision-making functions; Bernoulli r.v.s can characterize their outputs. Consider a decision function ƒ: X→{0,1}, where X=(X₁, . . . , Xₖ) denotes a real-valued input vector. Herein, the example uses R=ƒ(X) to simplify the remainder of the definitions. The grammar can be used to construct Bernoulli r.vs to support expressions beyond those that produce binary outputs. For example, a v-threshold based real-valued output, R′=(R>v) and a multi-class output, for class j, R′=(R==j) correspond to Bernoulli r.vs. Expressions involving R and Xᵢ act as the arguments <E> to construct an <ET erm>. For example, [symbol] [R>0|X₁+X₂>a]. c terms represent constant real values used as bounds for specifications. The example modified the grammar to include two additional operations. First, the example added a given argument to [symbol] , which allows a user to specify conditional probabilities directly, in contrast to specifying it as a ratio of joint/marginal probabilities.

$$\frac{𝔼 ( A ∨ ( B = b ) )}{𝔼 ( B = b )} \to 𝔼 ( A , given = ( B = b ) )$$

which is used to represent [symbol] [A|B=b], simplifying expressions for group fairness specification. Additionally, the example added comparison operators, which further simplify the process of writing specifications.

Generating the bounds for a specification requires propagating them from elementary subexpressions. Assuming that observed values for each [symbol] E> correspond to an underlying random variable X, a probabilistic guarantee ϕ_{X} for an elementary subexpression consists of an empirical estimate [symbol] [X], a concentration bound ε_{X}, and a failure probability δ_{X}, such that Pr[| [symbol] [X]− [symbol] [X]|≥ε_{X}]≤δ_{X}. For compound expressions, the example can infer the implied guarantees that can be inferred with corresponding constraints. Each inference rule corresponds to a derivation in the DSL grammar. Inference rules have preconditions and postconditions that are in the form:

$$\frac{U \{ r \vert r ∈ \{ ϕ , ψ , C \} \}}{U \{ s \vert s ∈ \{ ϕ , ψ , C \} \}}$$

where ϕ denotes a claim for a subexpression, ψ for a <spec>. For example, consider the sum/difference rule. Starting with the assumptions ϕ_{X}:=( [symbol] [X], ε_{X}, δ_{X}), ϕ_{Y}:=( [symbol] [Y], ε_{Y}, δ_{Y}). Then the example has:

$$\vert 𝔼 [ X ] \pm 𝔼 [ Y ] - ( \overline{𝔼} [ X ] \pm \overline{𝔼} [ Y ] ) \vert \leq \vert 𝔼 [ X ] - \overline{𝔼} [ X ] \vert + \vert 𝔼 [ Y ] - \overline{𝔼} [ Y ] \vert \leq {ε}_{X} + {ε}_{Y}$$

$$i . e .$$

$${ϕ}_{X} , {ϕ}_{Y} ⇒ X \pm Y : ( \overline{𝔼} [ X ] \pm \overline{𝔼} [ Y ] , {ε}_{X} + {ε}_{Y} , {δ}_{X} + {δ}_{y} ) .$$

Inference rules can require constraints, for e.g., assume ϕ_{X}:=( [symbol] [X], ε_{X}, δ_{X}), [symbol] [X]>c. Then Pr[ [symbol] [X]< [symbol] [X]−ε_{X}]>1−δ If the constraint is added that [symbol] [X]−ε_{X}≥c, Pr[X<c]>1−δ, thus,

$${ϕ}_{X} ⇒ ψ := X > c : ( T , {δ}_{X} )$$

under the constraint { [symbol] [X]−ε_{X}≥c}

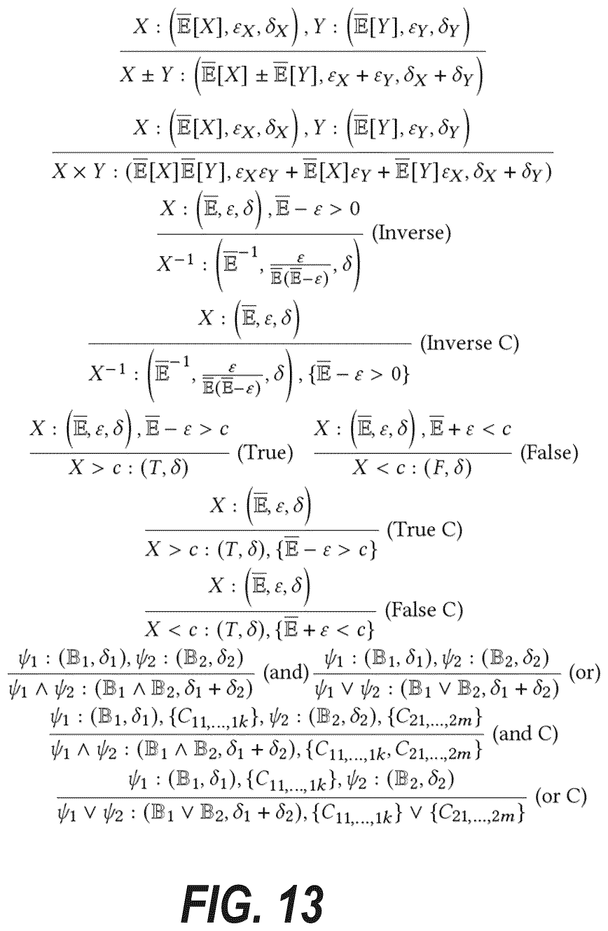

The complete set of inference rules required for the DSL is provided in FIG. 13. The implementation in AVOIR follows these rules but could be extended to other rule inference templates that support the DSL. Note that these rules extend the ones implemented by VF [4] with constraints that enable the optimizations required in AVOIR.

The pseudocode for the optimization procedure in AVOIR is described in Algorithm 1 shown in FIG. 2. The input to the algorithm can be the reporting threshold probability Δ and a specification v. The example implementation can infer a symbolic optimization problem corresponding to the bounds and failure probabilities of the elementary subexpressions. At each step, the OBSERVE(X) function is called with the new observation of every elementary subexpression and output. The empirical running means and counts of observations are updated. The final optimization problem OPT corresponding to each specification is a nonlinear constrained optimization problem. If a solution is successfully found for OPT, the algorithm terminates, and the estimate for the specification has reached the required threshold. If no solution is found, the estimates can be updated with δᵢ=Δ for each elementary subexpression. The intuition behind the algorithm is to use a confidence sequence corresponding to the estimates of elementary subexpressions at each time step. The inferred OPT has the form

$${min}_{0 \leq {δ}_{i} \leq 1} {Σ}_{i = 1}^{n} {δ}_{i}$$

$$s . t .$$

$${g}_{k} ( {δ}_{1 , … , n} , \overline{𝔼} [ {X}_{1} ] , … , \overline{𝔼} [ {X}_{n} ] ) \leq {ε}_{k}$$

where gₖ, εₖ are the functions/bounds derived using the transformations carried out through the inference rules.

Definition 1. For δ∈[0,1], a1−δ confidence sequence is a sequence of confidence sets, usually intervals (CIₜ)ₜ₌₁^{∞}, CIₜ:=(Lₜ, Rₜ)⊆ [symbol] satisfying a uniform convergence guarantee. After observing the t^{th} unit, the example calculated an updated confidence set CIₜ for an unknown quantity θₜ with the coverage property Pr(∀t≥1, θₜ: θₜ∈CIₜ)≥1−δ[25].

The example focused on the mean of r.v.s [symbol] [X] that constitute estimates for elementary subexpressions as the quantities of interest. The example implementation uses adaptive concentration inequalities to construct these confidence sequences. Any adaptive concentration inequality that can be applied to an r.v. X∈{0,1} such that

$$Pr [ \vert {\overline{𝔼}}_{t} [ X ] - 𝔼 [ X ] \vert \geq ε ( t , δ ) ] \leq δ$$

can be used in AVOIR. Here, [symbol] ₜ[X] is the empirical estimate of [symbol] [X] after the t^{th} observation. For comparison with previous work (e.g., VF), the example used the Adaptive Hoeffding Inequality AlN_{H} [48].

Theorem 1 (AlN_{H}). Given a Bernoulli random variable X with distribution P_{X}. Let {Xᵢ˜P_{X}}, i∈ [symbol] be i.i.d samples of X. Let

$${\overline{𝔼}}_{t} [ X ] = \frac{1}{t} {Σ}_{i = 1}^{t} {X}_{i}$$

Let [symbol] be a r.v on [symbol] ∪{∞} such that Pr[ [symbol] <∞]=1, and let

$$ε ( δ , t ) = \sqrt{( \frac{3}{5} log ( {log}_{1.1} t + 1 ) + \frac{5}{9} log ( 24 / δ ) ) / t}$$

Then, for any δ∈ [symbol] ₊,

$$Pr [ \vert {\overline{𝔼}}_{𝒯} [ X ] - 𝔼 [ X ] \vert \leq ε ( δ , 𝒯 ) \vert ] \geq 1 - δ$$

The example generated estimates using AlN_{H} and Corollary 4.1 for elementary subexpressions that are valid nonasymptotically (i.e., ∀t>1) and then expand this to compound subexpressions.

THEOREM 2. The sequences of estimates generated by AVOIR form a confidence set.

The intuition for the proof is as follows: first, for elementary subexpression X, let the failure probability at the stopping time be δ_{X}*. From eq. (1), the example shows that Δ≥δ_{X}*. Further, ε(δ, t) is monotonically decreasing in δ. Thus, setting δ_{X}(t)=Δ as per Algorithm 1 before stopping time will ensure that the estimated confidence intervals before the stopping time corresponding to each time step for X would be a subset of the optimized values,

$$( {\overline{𝔼} [ X ]}_{t} \pm ε ( {δ}_{X}^{*} , t ) ) ⊆ ( {\overline{𝔼} [ X ]}_{t} \pm ε ( Δ , t ) )$$

where (μ±σ)=(μ−σ,μ+σ). Next, for compound subexpressions and specifications, the correctness of the inference rules used for propagating bounds (FIG. 13) can be used to prove that the confidence sequence is valid nonasymptotically. The example includes a proof. First, the example assumes the existence of a confidence sequence for the mean of each elementary subexpression (e.g., using Theorem 1). That is, the example uses an AlN for ε(t, δ) such that

$$Pr [ ∀ t \geq 1 , \vert {\overline{𝔼}}_{t} [ X ] - 𝔼 [ X ] \vert \leq ε ( t , {δ}_{X} ) ] \geq 1 - {δ}_{X}$$

The example assumes ε(t, δ) to be monotonically non-increasing in δ and n. The example expects this to be the case for most AlN, since increasing the number of observations of increasing the failure threshold should allow for additional concentration around the mean (e.g., this holds for AlN_{H}) Second, the example assumes that except in degenerate cases, AVOIR terminates at finite stopping time [symbol] (termination criteria in Corollary 3.2, Appendix).

Proof. Elementary subexpressions: Consider a specification ψ consisting of elementary subexpressions X₁, . . . , Xₙ. At stopping time, let [symbol] :=( [symbol] [Xᵢ], ε( [symbol] , δ_{X}_{ᵢ}), δ_{X}_{ᵢ}) be the stopping time estimates. Then, from the termination criterion, a solution to the optimization problem OPT exists, i.e,

$$Δ \geq {\sum }_{i} {δ}_{{X}_{i}}$$

The sequence of bounds claimed by AVOIR are

$${ε}_{{X}_{i}} ( t ) = \{ \begin{matrix}ε ( Δ , t ) , & t < 𝒯 \\ ε ( {δ}_{{X}_{i}} , t ) , & t \geq 𝒯\end{matrix}$$

From equation 4 and since δᵢ∈[0,1]Δ≥δ_{X}_{ᵢ}. From the non-decreasing behavior of AlN

$$ε ( Δ , t ) \leq ε ( {δ}_{i} , t )$$

$$Now$$

$$\begin{matrix}Pr [ ∀ t \geq 1 , \vert {\overline{𝔼}}_{t} [ {X}_{i} ] - 𝔼 [ {X}_{i} ] \vert \leq {ε}_{{X}_{i}} ( t ) ] \\ = 1 - Pr [ ∃ t \geq 1 , \vert {\overline{𝔼}}_{t} [ {X}_{i} ] - 𝔼 [ {X}_{i} ] \vert > {ε}_{{X}_{i}} ( t ) ] \\ = 1 - Pr [ {⋃}_{t \geq 1} \{ \vert {\overline{𝔼}}_{t} [ {X}_{i} ] - 𝔼 [ {X}_{i} ] \vert > {ε}_{{X}_{i}} ( t ) \} ] \\ = 1 - Pr [ {⋃}_{t = 1}^{𝒯 - 1} \{ \vert {\overline{𝔼}}_{t} [ {X}_{i} ] - 𝔼 [ {X}_{i} ] \vert > {ε}_{{X}_{i}} ( t ) \} ⋃ \\ {⋃}_{t \geq T} \{ \vert {\overline{𝔼}}_{t} [ {X}_{i} ] - 𝔼 [ {X}_{i} ] \vert > {ε}_{{X}_{i}} ( t ) \} ] \} ⋃ \\ = 1 - Pr [ {⋃}_{t = 1}^{𝒯 - 1} \{ \vert {\overline{𝔼}}_{t} [ {X}_{i} ] - 𝔼 [ {X}_{i} ] \vert > ε ( {δ}_{{X}_{i}} , t ) \\ ⋃ \vert {\overline{𝔼}}_{t} [ {X}_{i} ] - 𝔼 [ {X}_{i} ] \vert ∈ ( ε ( Δ , t ) , ε ( {δ}_{{X}_{i}} , t ) ] \} ∪ \\ {⋃}_{t \geq 𝒯} \{ \vert {\overline{𝔼}}_{t} [ {X}_{i} ] - 𝔼 [ {X}_{i} ] \vert > ε ( {δ}_{{X}_{i}} , t ) \} ] \\ = 1 - Pr [ {⋃}_{t = 1}^{𝒯 - 1} \{ \vert {\overline{𝔼}}_{t} [ {X}_{i} ] - 𝔼 [ {X}_{i} ] \vert ∈ \\ ( ε ( Δ , t ) , ε ( {δ}_{{X}_{i}} , t ) ] \} ⋃ \\ {⋃}_{t \geq 1} \{ \vert {\overline{𝔼}}_{t} [ {X}_{i} ] - 𝔼 [ {X}_{i} ] \vert > ε ( {δ}_{{X}_{i}} , t ) \} ] \\ \geq 1 - Pr [ {⋃}_{t \geq 1} \{ \vert {\overline{𝔼}}_{t} [ {X}_{i} ] - 𝔼 [ {X}_{i} ] \vert > ε ( {δ}_{{X}_{i}} , t ) \} ] \\ = 1 - Pr [ ∃ t \geq 1 , \vert {\overline{𝔼}}_{t} [ {X}_{i} ] - 𝔼 [ {X}_{i} ] \vert > ε ( {δ}_{{X}_{i}} , t ) ] \\ \geq 1 - {δ}_{{X}_{i}}\end{matrix}$$

where the last step follows from the definition of the AlN used. Thus, ε_{X}_{ᵢ}(t) defines a 1−δ_{X}_{ᵢ} confidence sequence for [symbol] [Xᵢ].

Compound subexpressions: Consider a non-specification compound ( ) Cⱼ consisting of elementary subexpressions with indices Cⱼ={{j₁,j₂, . . . , j_{M}}} as the decision r.v.s, i.e, Xⱼ_{₁} . . . , Xⱼ_{_{M}}. Note that Cⱼ is a multiset as the same expression could occur multiple times within Cⱼ. At stopping time [symbol] ,

$${ϕ}_{{C}_{j}}^{𝒯} : ( {\overline{𝔼}}_{𝒯} [ {C}_{j} ] , {δ}_{{C}_{j}} , {ε}_{{C}_{j}} )$$

$$where {\overline{𝔼}}_{𝒯} [ {C}_{j} ] , {δ}_{{C}_{j}} , {ε}_{{C}_{j}}$$

are the corresponding values computed through the inference rules. In general, denoted by

$${\overline{𝔼}}_{t} [ {C}_{j} ] , {δ}_{{C}_{j}} ( t ) , {ε}_{{C}_{j}} ( t ) = INFER ( {ϕ}_{{X}_{{j}_{1}}}^{t} , … , {ϕ}_{{X}_{{j}_{M}}}^{t} )$$

the values inferred at t, using the inference rules INFER. Now,

$$\begin{matrix}Pr [ ∃ t \geq 1 , \vert {𝔼}_{t} [ {C}_{j} ] - \overline{𝔼} [ {C}_{j} ] \vert > {ε}_{{C}_{j}} ( t ) ] \\ \leq Pr [ {⋃}_{i = 1}^{M} ∃ t \geq 1 , ¬ {ϕ}_{{X}_{{j}_{i}}}^{t} ] ( eq . ( 8 ) ) \\ \leq {\sum }_{i ∈ {C}_{j}} Pr [ ∃ t \geq 1 , ¬ {ϕ}_{{X}_{{j}_{i}}}^{t} ] ( union bound ) \\ = {\sum }_{i ∈ {C}_{j}} Pr [ ∃ t \geq 1 , \vert {\overline{𝔼}}_{t} [ {X}_{{j}_{i}} ] - {𝔼}_{t} [ {X}_{{j}_{i}} \vert > {ε}_{{X}_{{j}_{i}}} ( t ) ] \\ ( definition of {ϕ}_{{X}_{{j}_{i}}^{t}} ) \\ \leq {\sum }_{i ∈ {C}_{j}} {δ}_{{X}_{{j}_{i}}} ( elementary subexpressions ) \\ \leq {δ}_{{C}_{j}} ( eq . ( 8 ) at t = 𝒯 )\end{matrix}$$

Therefore ε_{C}_{ⱼ}(t) defines a 1−δ_{C}_{ⱼ} confidence sequence for [symbol] [Cⱼ]A similar proof can be constructed for any <spec>.

COROLLARY 2.1. The estimates for the overall specification ψ form a confidence sequence which satisfies ψ: (b, Δ), b∈{T, F} at [symbol] .

Proof. The example initialized the main specification with the required failure probability Δ. At termination, Σδᵢ≤Δ. From Theorem 2, the example can infer that the confidence sequence corresponding to the termination achieves the threshold Δ, as required.

Improvements over Baseline were shown. δᵢ for each elementary subexpressions is set to Δ/n, where n is the number of elementary subexpressions in the specification. This simplification uses the assumption Δ_{δ}:=δᵢ=δⱼ∀i, j for elementary subexpressions. As the example does not make this assumption, the example can prove the following critical theorem (note, Corollary 3.2 describes the conditions required for finite stopping).

Definition 2. The example defines the specification stopping time [symbol] for a confidence sequence as the smallest t such that given a threshold Δ and a specification ψ, an inference algorithm terminates with Pr[∀t≥1, ψₜ= [symbol] ]≥1−Δ, where [symbol] is the estimate of ψ at [symbol] .

THEOREM 3. Given a threshold probability Δ for a specification ψ, let the stopping time for AVOIR be [symbol] and the stopping time with the A_{δ} assumption be [symbol] ⁺. Then [symbol] ≤ [symbol] ⁺.

Proof. Under A_{δ}, at the stopping time [symbol] ⁺, δᵢ⁺=Δ/n, with Σᵢ₌₁ⁿδᵢ⁺=Δ. As δᵢ⁺ are propagated using INFER (without constraint rules), they satisfy the constraints of the optimization problem in eq. (1). At time [symbol] ⁺ AVOIR can find solution δᵢ* such that minimizes Σᵢ₌₁ⁿδᵢ.

$${\sum }_{i = 1}^{n} {δ}_{i}^{*} \leq {\sum }_{i = 1}^{n} {δ}_{i}^{+} = Δ$$

Thus, AVOIR would have terminated by step [symbol] ⁺, but can find a feasible solution at an earlier step, i.e., [symbol] ≤ [symbol] ⁺.

The example built a Python library to create specifications as a decorator over decision functions. New input/output observations are monitored to update all the terms in a specification. Inference for evaluating the value and bounds is carried out via operator overloading. In line with previous work [1,2,4] on distributional verification, the example used rejection sampling for conditional probability estimation. The example used the COIN-OR implementation of IPOPT [42], accessed through the Pyomo [23] interface for optimization.

In this section, the example evaluated AVOIR variants through three real-world case studies. Direct comparisons with existing work are impossible since no other work (to our knowledge) facilitates a general-purpose inference engine for online fairness auditing using arbitrary measures. The example can, however, implement VF's [4] inference rules within AVOIR (denoted as AVOIR-VF). Note that AVOIR-VF sidesteps the assumptions of having a known data-generating distribution (made possible by AVOIR's reliance on confidence sets), making this variation a more practical and efficient algorithm. The example herein denotes AVOIR-OB as the implementation that utilizes the abovementioned optimizations. Across the studies, the role of chosen threshold probabilities is similar to that of p-values in statistics. Typical p-values tend to be 0.05 and 0.1, which the example demonstrates in the RateMyProfs and COMPAS risk assessment example examples described herein. The example expects that regulators will set the threshold probabilities on a case-by-case basis, e.g., 0.15 for illustration purposes in the adult income example.

This example implementation provides a detailed black-box machine learning model based case example on a real-world dataset. This case example uses the Rate My Professors (RMP) dataset [28]. This dataset includes professor names and reviews for them written by students in their classes, ratings, and certain self-reported attributes of the reviewer. Ratings are provided on a five-point scale (1-5 stars). The example uses the preprocessing described in [28] to infer the gender attribute for the professors. This dataset is divided into an 80-20 split (train-test). The example then trained a BERT-based transformer model [11] on the training split. The example used the implementation from the simple transformers ⁴ package. The loss function chosen is the mean-squared error from the true ratings. On the test set, the example track a gender-fairness specification in the model outputs:

$$( E [ r > 3 \vert = gender = F ] / E [ r > 3 \vert gender = M < 1.2 ) \& ( E [ r > 3 \vert gender = M ) ] / E [ r > 3 \vert gender = F ] > 0.8 )$$

The example sets the failure probability Δ=0.05. OPT is run after each batch (5 items/batch). FIG. 10 shows that AVOIR-OB ⁵ can provide a guarantee in 2.5% fewer iterations than AVOIR-VF. The OB guarantee provided tries to optimize for the failure probability while staying under the required threshold, remaining closer to the required threshold in subsequent steps. FIG. 10 illustrates bounds for first half of a gender-fairness specification generated by AVOIR-OB and AVOIR-VF for RateMyProfs, a real-world dataset. Vertical lines show the step at which the methods can provide a guarantee of failure for the upper bounds with. The horizontal line represents the constant term in the inequality.

The example analyzed the Adult income dataset [30]. The historical dataset labels individuals from the 1994 census as having a high-income (>50k a year) or not (≤50k a year). The example considers this column of data as a black-box measurement. US Federal laws mandate against race and sex-based discrimination. Thus, the specification the example starts the analysis with is a group fairness property for federal employees that monitors the difference of the proportions of individuals with sex marked male vs. female with a high income should be less than 0.5. In addition, the example ensure that the difference between individuals with race marked white and non-white should have a difference of less than 0.5. Thus, the example uses an intersectional fairness criterion. The associated specification is given below, where h is an indicator for whether an individual is high-income is the binary classification output of our model:

$$( E [ h \vert sex = M ] - E [ h \vert sex = F ] < 0 \text{.5} ) \& \text{} \backslash ( E [ h \vert race = W ] - E [ h \vert race ! = W ] < 0.5 )$$

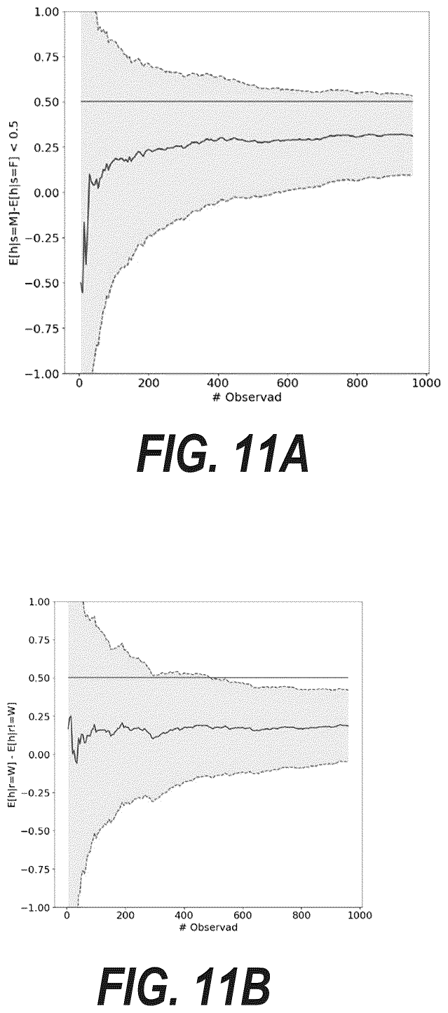

In this example, the example set the failure threshold probability Δ=0.15 When run with this specification, the generated bounds may not be achieved with the available data. The example can then use the iterative refinement associated with subexpressions to analyze different components of the specification. The plot corresponding to the left subexpression is shown in FIG. 11A shows that guarantees cannot converge under the threshold with the given number of data samples. FIG. 11A and FIG. 11B show the bounds of an output of the example implementation of the present disclosure as the number of observations increases. An auditor can now choose to either reduce the guarantee (i.e. increase A) or increase the threshold. Analyzing the right subexpression, the race group fairness term can be guaranteed to be under the threshold (FIG. 11B). Using this information, an auditor can make a decision to increase the threshold on the group fairness term for sex. As a hypothetical, suppose they increase it from 0.5 to 0.55 and rerun the analysis. OB can provide a guarantee at this threshold within 870 steps, whereas VF can provide it at 960 steps, demonstrating a relative improvement of about 10.35%. Additionally, the optimal Δ split across the terms is ≈(0.135,0.36*10⁴), which is far from the equal split allocated by VF. The reason for this split is that increasing the threshold for the first time provides the optimizer with additional legroom to better distribute the failure probabilities between the two terms.

The Correctional Offender Management Profiling for Alternative Sanctions (COMPAS) recidivism risk score data is a popular dataset for assessing machine bias of commercial tools used to assess a criminal defendant's likelihood to re-offend. The data is based on recidivism (re-offending) scores derived from software released by Northpointe and widely used across the United States for making sentencing decisions. In 2016, Angwin et al. [3] at ProPublica released an article and associated analysis code critiquing machine bias associated with race present in the COMPAS risk scores for a set of arrested individuals in Broward County, Florida, over two years. The analysis concluded that there were significant differences in the risk assessments of African-American and Caucasian individuals. Northpointe pushed back in a report [12] firmly rejecting the claims made by the ProPublica article; instead, Northpointe claimed that Angwin et al. [3] made several statistical and technical errors in the report. This case example used AVOIR to example the claims of the two reports mentioned above. The example created a materialized view of the ProPublica dataset by reproducing the preprocessing steps in the publicly available ProPublica analysis notebook. The example looks at “Sample A” [12], where the analysis of the “not low” risk assessments using a logistic regression model reveals a high coefficient associated with the factor associated with race being African-American. In terms of a fairness metric, this corresponds to false positive rate (FPR) balance (predictive equality) [41] metrics. The associated specification in AVOIR grammar would be:

$$E [ hrisk \vert race = African - American \& recid = 0 ] \text{} / \text{} E [ hrisk \vert race = Caucasian \& recid = 0 ] < 1.1$$

Where hrisk is an indicator for high-risk assessments made by the black-box COMPAS tool as defined by Angwin et al. [3], recid is an indicator for re-offending within two years of first arrest, and a 90%-rule is used as the threshold. The example chose a failure threshold probability of Δ=0.1, with the optimization run after every batch of 5 samples. AVOIR finds that when the decisions are made sequentially, online, the assertion for specification violation cannot be made with the required failure guarantee.

By analyzing the component subexpressions, it can be determined that that AVOIR may not optimize since the lower FPR in the denominator (FPR for Caucasian individuals) increases the overall variance and limits the ability to optimize for guarantees. The example follows this analysis by using the reciprocal specification, i.e.,

$$E [ hrisk race = Caucasian \backslash \& recid = 0 ] \text{} / E [ hrisk race = African - American \backslash \& recid = 0 ] > 0.9$$

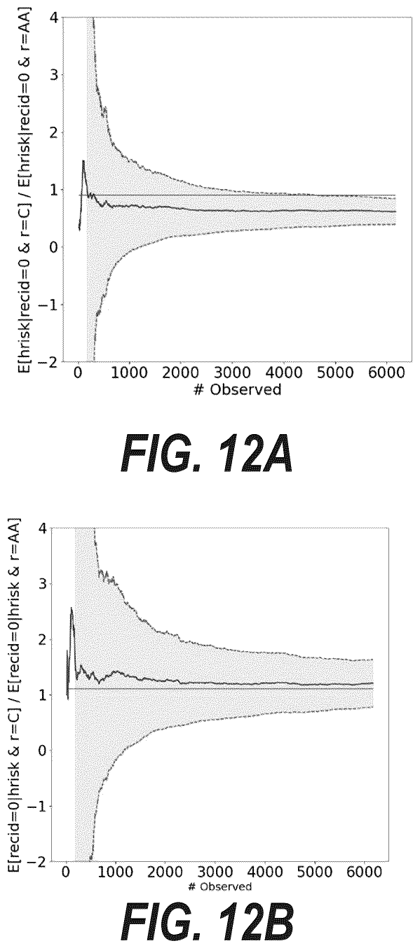

The example finds that the specification is guaranteed to be violated with a confidence of over 1−Δ=0.9 probability, and AVOIR can detect this violation within about half the number of available assessments (3350 steps) when run in an online setting. FIG. 12A demonstrates the progression of the tracked expectation term. Thus, if deployed with the corrected specification, AVOIR would be able to alert Northpointe/an auditor of a violation/potentially-biased decision-making tool.

The Northpointe report [12] makes several claims about the shortcomings of this analysis. One of the primary claims is that Angwin et al. [3] used an analysis based on “Model Errors” rather than “Target Population Errors”. In fairness specification terms, this refers to the difference between a False Positive Rate (FPR) balance vs. False Discovery Rate (FDR) balance, i.e., balancing for predictive parity over predictive equality. In probabilistic terms, the difference amounts to comparing Pr[Ŷ=1|Y=0, g=1,2] (FPR) vs Pr[Y=0|Ŷ=1, g=1,2] (FDR), where Ŷ refers to the decision made by the algorithm, Y refers to the true value, and g=1,2 reflects group membership [41]. This analysis is run on the dataset subset dubbed “Sample B”. To test their hypothesis, the example reproduced the corresponding preprocessing steps and run both versions (numerator and denominator being Caucasian) of the corresponding specification under the same setup as earlier. Despite the point estimate being within the required threshold, the example finds that neither version can be guaranteed with the required confidence in the given data. The example describes only one of the two variants with the corresponding FIG. 12B.

$$E [ recid = 0 \vert race = Caucasian \& hrisk ] \text{} / E [ recid = 0 \vert race = African - American \& hrisk ] > 0.9$$

The Northpointe report [12] does not provide confidence intervals for their claim. Further, even though the report does not release associated code, the point estimates of the False Discovery Rates (FDRs) match those present in the report, which increases the confidence in our AVOIR-based analysis.

The back-and-forth exchange has been the subject of much discussion in academic and journalistic publications [16, 43]. Seminal work by Kleinberg et al. [29] proved the impossibility of simultaneously guaranteeing certain combinations of fairness metrics. While AVOIR cannot circumvent this problem, its usage can help audit claimed guarantees on defined metrics. AVOIR lends itself to successful analysis that is not possible with the VF implementation available online, which only provides support for a predefined set of specifications and requires access to a data-generating function. In addition, the example chose 0.1 as the failure probability because it is one of the thresholds used in [3]. The example set it to the highest used threshold to allow leeway for the claim by Northpointe. Even under this lax threshold, the analysis by Northpointe fails.

Subtle changes in fairness criteria definitions can change the implications on decision-making [7]. Practitioners need support when selecting, designing, and guaranteeing fairness for deployed machine learning algorithms. Prior work on fairness has helped develop nuanced notions and algorithms to help train more ‘fair’ machine learning models. These include group fairness measures such as inter alia, minimizing disparate impact [6,15], maximizing the equality of opportunity [22] In contrast with group fairness notions, causal notions of fairness [31] and individualized notions of fairness [13] provide alternative statistical mechanisms for understanding discriminatory behaviors of automated decision systems. Thomas et al. [38] proposed the Seldonian Framework as a generic mechanism for model users to design algorithms that help train machine learning models that can regulate them against undesirable behaviors. Yan and Zhang [45] propose a query-efficient framework to audit an unknown function chosen from a known hypothesis class of decision-making functions.

The example herein focused on the problem of detecting and diagnosing whether systems designed under any framework follow any prescribed regulatory constraints supported within the grammar of AVOIR. That is, the example implementation is agnostic to the framework; instead, the example is interested in testing the adherence of models to specified criteria. The example used a probabilistic framework to verify this behavior. Alternative frameworks such as the AI Fairness 360 [5] provide mechanisms to quantify fairness uncertainty, though they are restricted to pre-supported metrics. Uncertainty quantification [20,21] is an alternative mechanism to provide adaptive guarantees. However, existing work is designed for commonly used outcome metrics, such as accuracy and F1-score, rather than for fairness metrics. Justicia [19] optimizes uncertainty for fairness metrics estimates using stochastic SAT solvers but can only be applied to a limited class of tree-based classification algorithms.

Machine learning testing [47] is an avenue that can expose undesired behavior and improve the trustworthiness of machine learning systems. Prior work on fairness testing is most closely related to AVOIR. Fairness testing [18] provides a notion of causal fairness and generates tests to check the fairness of a given decision-making procedure. Given a specific definition of fairness, Fairtest [39] and Verifair (VF) [4] build a comprehensive framework for investigating fairness in data-driven pipelines. Fairness-aware Programming (FP) [2] combined the two demands of machine learning testing and fairness auditing to make fairness a first-class concern in programming. Fairness-aware programming applies a runtime monitoring system for a decision-making procedure with respect to an initially stated fairness specification. The overall failure probability of an assertion is computed as the sum of the failure probabilities of each constituting sub-expression (using the union bound). FP does not provide any specific mechanism for splitting uncertainty, and Verifair splits it equally across all constituent elementary subexpressions. Thus, assertion bounds for subexpressions in both FP and VF are split inefficiently compared to AVOIR.

The AVOIR framework can easily define and monitor fairness specifications online and aid in the refinement of specifications. AVOIR is easy to integrate within modern database systems and can alternatively or additionally also serve as a standalone system evaluating whether blackbox machine learning models meet specific fairness criteria on specific datasets (including both structured and unstructured data) as described in our case studies. AVOIR extends the grammar from Fairness Aware Programming [2] with operations that enhance expressiveness. In addition, the example derives probabilistic guarantees that improve the confidence with which specification violations are reported. The example described herein demonstrates that AVOIR can provide users with insights and context that contribute directly to refinement decisions. The example further shows the robustness of AVOIR, by evaluating it along two dimensions: the data/ML model used and changing parameters (thresholds, fairness definitions). Additionally, the example demonstrated the robustness of the data/model used by evaluating three datasets of varying domains and types (criminal justice—COMPAS, text classification—RateMyProfs, census data—Adult Income). For robustness to the thresholds, the example used varying failure probability levels (0.05,0.1,0.15) in our case studies. Note that any probability thresholds over these values for the corresponding studies would converge in fewer iterations, while lower thresholds would require additional data samples.

The present disclosure also contemplates that implementations of the present disclosure can further suggest edits that are likely to achieve the desired intent of a model developer. Implementations of the present disclosure can provide intelligent specification refinement suggestions and support distributed machine learning settings. In addition to improving the usability of our tools for making fairness specification refinements, implementations of the present disclosure can include scalable frameworks. While the example of the example implementation looked at a single model with respect to a single dataset, the present disclosure contemplates the use of many models and/or many datasets being evaluated. Real-world deployment of machine learning often contains many clients with models and datasets that may evolve and drift over time. Implementations of the present disclosure can also examine efficient monitoring of machine learning behavior for a fairness specification in a distributed context, enabling horizontal scalability. Alternatively or additionally, decoupling the observation of data and reporting results from monitoring the results are promising and can lead to the desired scalability.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] Aws Albarghouthi, Loris D'Antoni, Samuel Drews, and Aditya V Nori. 2017. Fairsquare: probabilistic verification of program fairness. Proceedings of the ACM on Programming Languages 1, OOPSLA (2017), 1-30.
[2] Aws Albarghouthi and Samuel Vinitsky. 2019. Fairness-Aware Programming. In Proceedings of the Conference on Fairness, Accountability, and Transparency (Atlanta, GA, USA) (FAT* '19). Association for Computing Machinery, New York, NY, USA, 211-219. https://doi.org/10.1145/3287560.3287588
[3] Julia Angwin, Jeff Larson, Surya Mattu, and Lauren Kirchner. 2016. Machine bias. In Ethics of Data and Analytics. Auerbach Publications, 254-264.
[4] Osbert Bastani, Xin Zhang, and Armando Solar-Lezama. 2019. Probabilistic verification of fairness properties via concentration. Proceedings of the ACM on Programming Languages 3, OOPSLA (2019), 1-27.
[5] R. K. E. Bellamy, K. Dey, M. Hind, S. C. Hoffman, S. Houde, K. Kannan, P. Lohia, J. Martino, S. Mehta, A. Mojsilović, S. Nagar, K. Natesan Ramamurthy, J. Richards, D. Saha, P. Sattigeri, M. Singh, K. R. Varshney, and Y. Zhang. 2019. AI Fairness 360: An extensible toolkit for detecting and mitigating algorithmic bias. IBM Journal of Research and Development 63, 4/5 (2019), 4:1-4:15. https://doi.org/10 1147/JRD.2019.2942287
[6] Toon Calders, Faisal Kamiran, and Mykola Pechenizkiy. 2009. Building classifiers with independency constraints. In 2009 IEEE International Conference on Data Mining Workshops. IEEE, 13-18.
[7] Alessandro Castelnovo, Riccardo Crupi, Greta Greco, and Daniele Regoli. 2021 The zoo of fairness metrics in machine learning. arXiv preprint arXiv:2106.00467 (2021).
[8] Alexandra Chouldechova. 2017. Fair prediction with disparate impact: A study of bias in recidivism prediction instruments. Big data 5, 2 (2017), 153-163.
[9] US Congress. 2023. H.R. 3369—AI Accountability Act. https://www.congress.gov/bill/118th-congress/house-bill/3369/text
[10] A Feder Cooper, Emanuel Moss, Benjamin Laufer, and Helen Nissenbaum. 2022. Accountability in an algorithmic society: relationality, responsibility, and robustness in machine learning. In 2022 ACM Conference on Fairness, Accountability, and Transparency. 864-876.
[11] Jacob Devlin, Ming-Wei Chang, Kenton Lee, and Kristina Toutanova. 2019. BERT: Pre-training of Deep Bidirectional Transformers for Language Understanding. In Proceedings of the 2019 Conference of the North American Chapter of the Association for Computational Linguistics: Human Language Technologies, Volume 1 (Long and Short Papers). Association for Computational Linguistics, Minneapolis, Minnesota, 4171-4186. https://doi.org/10.18653/v1/N19-1423
[12] William Dieterich, Christina Mendoza, and Tim Brennan. 2016. COMPAS risk scales: Demonstrating accuracy equity and predictive parity. Northpointe Inc 7, 4 (2016).
[13] Cynthia Dwork, Moritz Hardt, Toniann Pitassi, Omer Reingold, and Richard Zemel. 2012. Fairness through awareness. In Proceedings of the 3rd innovations in theoretical computer science conference. 214-226.
[14] The U.S. EEOC. 1979. Uniform guidelines on employee selection procedures. (March 1979)
[15] Michael Feldman, Sorelle A Friedler, John Moeller, Carlos Scheidegger, and Suresh Venkatasubramanian. 2015. Certifying and removing disparate impact. In proceedings of the 21th ACM SIGKDD international conference on knowledge discovery and data mining. 259-268.
[16] Avi Feller, Emma Pierson, Sam Corbett-Davies, and Sharad Goel. 2016. A computer program used for bail and sentencing decisions was labeled biased against blacks. It's actually not that clear. The Washington Post 17 (2016).
[17] Gemma Galdon Clavell, Mariano Martín Zamorano, Carlos Castillo, Oliver Smith, and Aleksandar Matic. 2020. Auditing Algorithms: On Lessons Learned and the Risks of Data Minimization. Association for Computing Machinery, 265-271.
[18] Sainyam Galhotra, Yuriy Brun, and Alexandra Meliou. 2017. Fairness testing: testing software for discrimination. In Proceedings of the 2017 11th foint meeting on foundations of software engineering. 498-510.
[19] Bishwamittra Ghosh, Debabrota Basu, and Kuldeep S Meel. 2021. Justicia: a stochastic SAT approach to formally verify fairness. In Proceedings of the AAAI Conference on Artificial Intelligence. 7554-7563.
[20] Soumya Ghosh, Q Vera Liao, Karthikeyan Natesan Ramamurthy, Jiri Navratil, Prasanna Sattigeri, Kush R Varshney, and Yunfeng Zhang. 2021. Uncertainty Quantification 360: A Holistic Toolkit for Quantifying and Communicating the Uncertainty of AI. arXiv preprint arXiv:2106.01410 (2021).
[21] Tony Ginart, Martin Jinye Zhang, and James Zou. 2022. MLDemon: Deployment Monitoring for Machine Learning Systems. In International Conference on Artificial Intelligence and Statistics. PMLR, 3962-3997.
[22] Moritz Hardt, Eric Price, and Nati Srebro. 2016. Equality of opportunity in supervised learning. Advances in neural information processing systems 29 (2016).
[23] William E Hart, Jean-Paul Watson, and David L Woodruff. 2011. Pyomo: modeling and solving mathematical programs in Python. Mathematical Programming Computation 3, 3 (2011), 219-260.
[24] Dennis Hirsch, Tim Bartley, Arvind Chandrasekaran, Srinivasan Parthasarathy, Piers Turner, Devon Norris, Keir Lamont, and Christina Drummond. 2020. Corporate Data Ethics: Data Governance Transformations for the Age of Advanced Analytics and AI (Final Report). In Appeared at the Privacy Law Scholars Conference (also available as SSRN Abstract: 3828239).
[25] Steven R Howard, Aaditya Ramdas, Jon Mcauliffe, and Jasjeet Sekhon. 2021. Time-uniform, nonparametric, nonasymptotic confidence sequences. The Annals of Statistics 49, 2 (2021), 1055-1080.
[26] Disi Ji, Padhraic Smyth, and Mark Steyvers. 2020. Can i trust my fairness metric? assessing fairness with unlabeled data and bayesian inference. Advances in Neural Information Processing Systems 33 (2020), 18600-18612.
[27] B Justice Srikrishna. 2018. A free and fair digital economy: Protecting privacy, empowering Indians.
[28] Moniba Keymanesh, Tanya Berger-Wolf, Micha Elsner, and Srinivasan Parthasarathy. 2021. Fairness-aware summarization for justified decision-making. arXiv preprint arXiv:2107.06243 (2021).
[29] Jon Kleinberg, Sendhil Mullainathan, and Manish Raghavan. 2017. Inherent TradeOffs in the Fair Determination of Risk Scores. In 8th Innovations in Theoretical Computer Science Conference (ITCS 2017) (Leibniz International Proceedings in Informatics (LIPIcs), Vol. 67), Christos H. Papadimitriou (Ed.). Schloss DagstuhlLeibniz-Zentrum fuer Informatik, Dagstuhl, Germany, 43:1-43:23. https://doi.org/10.4230/LIPIcs.ITCS.2017.43
[30] Ron Kohavi. 1996. Scaling up the accuracy of naive-bayes classifiers: A decisiontree hybrid. In Kdd, Vol. 96. 202-207.
[31] Matt J Kusner, Joshua Loftus, Chris Russell, and Ricardo Silva. 2017. Counterfactual fairness. Advances in neural information processing systems 30 (2017).
[32] Margaret Mitchell, Simone Wu, Andrew Zaldivar, Parker Barnes, Lucy Vasserman, Ben Hutchinson, Elena Spitzer, Inioluwa Deborah Raji, and Timnit Gebru. 2019. Model cards for model reporting. In Proceedings of the conference on fairness, accountability, and transparency. 220-229.
[33] E. F. Moore. 1956. Gedanken-experiments on sequential machines. Automata Studies, Princeton University Press 129-153 (1956).
[34] Helen Nissenbaum. 1996. Accountability in a computerized society. Science and engineering ethics 2, 1 (1996), 25-42.
[35] Central Digital Office and Data. 2021. Algorithmic transparency standard. https://www.gov.uk/government/collections/algorithmic-transparency-standard
[36] European Parliament. 2018. 2018 reform of EU data protection rules. European Commission (2018)
[37] Kacper Sokol and Peter Flach. 2020. Explainability fact sheets: a framework for systematic assessment of explainable approaches. In Proceedings of the 2020 Conference on Fairness, Accountability, and Transparency. 56-67.
[38] Philip S Thomas, Bruno Castro da Silva, Andrew G Barto, Stephen Giguere, Yuriy Brun, and Emma Brunskill. 2019. Preventing undesirable behavior of intelligent machines. Science 366, 6468 (2019), 999-1004.
[39] Florian Tramer, Vaggelis Atlidakis, Roxana Geambasu, Daniel Hsu, Jean-Pierre Hubaux, Mathias Humbert, Ari Juels, and Huang Lin. 2017. FairTest: Discovering Unwarranted Associations in Data-Driven Applications. In 2017 IEEE European Symposium on Security and Privacy (EuroS P). 401-416. https://doi.org/10.1109/EuroSP.2017.29
[40] Richard Vanderford. 2022. New York's Landmark AI Bias Law Prompts Uncertainty. WSf (2022). https://www.wsj.com/articles/new-yorks-landmark-ai-biaslaw-prompts-uncertainty-11663752602
[41] Sahil Verma and Julia Rubin. 2018. Fairness definitions explained. In 2018 ieee/acm international workshop on software fairness (fairware). IEEE, 1-7.
[42] Andreas Wächter and Lorenz T Biegler. 2006. On the implementation of an interior-point filter line-search algorithm for large-scale nonlinear programming. Mathematical programming 106, 1 (2006), 25-57.
[43] Anne L Washington. 2018. How to argue with an algorithm: Lessons from the COMPAS-ProPublica debate. Colo. Tech. Lf 17 (2018), 131.
[44] lan Waudby-Smith, David Arbour, Ritwik Sinha, Edward H Kennedy, and Aaditya Ramdas. 2021. Time-uniform central limit theory, asymptotic confidence sequences, and anytime-valid causal inference. arXiv preprint arXiv:2103.06476 (2021).
[45] Tom Yan and Chicheng Zhang. 2022. Active fairness auditing. In International Conference on Machine Learning. PMLR, 24929-24962.
[46] Muhammad Bilal Zafar, Isabel Valera, Manuel Gomez Rogriguez, and Krishna P Gummadi. 2017. Fairness constraints: Mechanisms for fair classification. In Artificial Intelligence and Statistics. PMLR, 962-970.
[47] Jie M. Zhang, Mark Harman, Lei Ma, and Yang Liu. 2020. Machine Learning Testing: Survey, Landscapes and Horizons. IEEE Transactions on Software Engineering (2020), 1-1. https://doi.org/10.1109/TSE.2019.2962027
[48] Shengjia Zhao, Enze Zhou, Ashish Sabharwal, and Stefano Ermon. 2016. Adaptive concentration inequalities for sequential decision problems. Advances in Neural Information Processing Systems 29 (2016).

What is claimed:

1. A computer implemented method for measuring fairness, the method comprising:
obtaining a deployed model and an audit dataset associated with the deployed model, wherein the audit dataset is configured to evaluate model fidelity against one or more fairness metrics;
specifying a fairness criterion on a plurality of population groups, the fairness criterion comprising one or more fairness metrics;
performing an evaluation of the deployed model with respect to the fairness criterion, wherein the evaluation of the fairness criterion comprises analyzing the audit dataset using the deployed model to predict a respective outcome metric for each of the population groups; and
generating a visual diagnostic diagram for facilitating an analysis of potential failures of the deployed model with respect to the specified fairness criterion.

2. The computer implemented method of claim 1, wherein obtaining the deployed model further comprises receiving the deployed model from a machine learning system, the machine learning system comprising a decision-making function, wherein the decision-making function comprises varying degrees of human intervention.

3. The computer implemented method of claim 2, wherein the decision-making function is unknown.

4. The computer implemented method of claim 2, wherein the decision-making function is arbitrary.

5. The computer implemented method of claim 1, wherein performing the evaluation of the deployed model comprises performing a sequence of estimates and generating a confidence set.

6. The computer implemented method of claim 1, wherein the audit dataset comprises data representing a relationship between an outcome metric and a population group.

7. The computer implemented method of claim 6, wherein the outcome data comprises data representing a relationship between an outcome metric and a plurality of population groups.

8. The computer implemented method of claim 1, wherein the visual diagnostic diagram is a syntax tree.

9. The computer implemented method of claim 8, wherein the syntax tree comprises an interactive syntax tree.

10. The computer implemented method of claim 1, wherein performing an evaluation of the deployed model comprises evaluating the deployed model based on a grammar.

11. The computer implemented method of claim 10, further comprising evaluating the deployed model based on a user input and outputting a revised output value.

12. The computer implemented method of claim 1, wherein the fairness criterion is predefined or dynamically varied.

13. The computer implemented method of claim 1, wherein the step of evaluating the deployed model is performed iteratively or continuously.

14. The computer implemented method of claim 1, wherein the step of evaluating the deployed model is performed without assumptions about the deployed model.

15. A system comprising:
a display;
a computing device operably coupled to the display, wherein the computing device comprises at least one processor and memory, the memory having computer-executable instructions stored thereon that, when executed by the at least one processor, cause the at least one processor to:
obtain a deployed model and an audit dataset associated with the deployed model, the dataset comprising evaluation data;
specify a fairness criterion on a plurality of population groups, the fairness criterion comprising one or more fairness metrics;
perform an evaluation of the deployed model with respect to the fairness criterion, wherein the evaluation of the fairness criterion comprises analyzing the audit dataset using the deployed model to predict a respective outcome metric for each of the population groups;
generate a visual diagnostic diagram for facilitating an analysis of potential failures of the deployed model with respect to the specified fairness criterion; and
display, by the display, the visual diagnostic diagram.

16. The system of claim 15, wherein the computing device is further configured to: receive a user input, evaluate the deployed model based on the user input, and output a revised output value by the display.

17. The system of claim 15, wherein the computing device is configured to iteratively or continuously evaluate the deployed model.

18. The system of claim 15, wherein the visual diagnostic diagram is a syntax tree.

19. The system of claim 18, wherein the syntax tree comprises an interactive syntax tree.

20. The system of claim 15, wherein the computing device is further configured to obtain the deployed model from a machine learning system, the machine learning system comprising a decision-making function wherein the decision-making function comprises varying degrees of human intervention.
